(19) United States
(12) Patent Application Publication
(10) Pub. No.: US 2004/0101300 A1
(43) Pub. Date: May 27, 2004

(54) Method and Circuit for Determing the Optical Signal to Noise Ratio for Optical Transmission

(76) Inventors: Joachim Bialas, Deisenhofen (DE); Anton Schex, Germering (DE)

Correspondence Address: BELL, BOYD & LLOYD, LLC, P. O. BOX 1135, CHICAGO, IL, 60690-1135, US

(21) Appl. No.: 10/275,454

(22) PCT Filed: May 3, 2001
(86) PCT No.: PCT/DE01/01687

(30) Foreign Application Priority Data
May 5, 2000 (DE) 100 21 860.1

(51) Int. Cl. H04B 10/18

(52) U.S. Cl. 398/26

(57) ABSTRACT

The invention relates to the determination of the carrier-to-noise ratio for optical transmissions when a noise-affected optical signal containing a message signal is transmitted along an optical signal transmission path, whereby the optical signal together with the optical noise transmitted therewith is fed to an optical filter (OF). The optical output signal from the above is converted into a corresponding electrical signal in a detector device (Det) and either the mid-frequency of the optical filter (OF), or the detector device (Det) is periodically modulated with a modulation signal (Um). The received total light power (Pges) is determined from a direct current component of the electrical signal and the signal power (Pse) of said message signal is determined from a time-dependent modulation component. The carrier-to-noise ratio is determined from the above parameters.

The invention relates to a method and a circuit arrangement for determining the optical signal to noise ratio (OSNR) for optical transmission of a noisy optical signal which is transmitted via an optical signal transmission path and which contains a user signal, by optical detection of the relevant optical signal and by determination of the user signal power and the noise signal power in order to form the optical signal to noise ratio.

Determination of the optical signal to noise ratio for optical signal transmission is of critical importance in the context of ensuring the transmission quality on an optical signal transmission path. An optical spectrum analyzer is conventionally used in order to determine the measurement variables which are required for the respective optical signal to noise ratio. A range of commercially available measurement instruments are available, which allow the determination of the wavelength, the user signal power and the optical signal to noise ratio of the respective optical signal transmission path. However, on the one hand, these instruments are relatively expensive and, on the other hand, their dimensions are considerable, for which reason they are unsuitable for mobile use.

The optical signal to noise ratio OSNR is defined as the ratio between the user signal power at the user signal wavelength λ and the optical noise power within a predetermined bandwidth around the relevant user signal wavelength. The most usual procedure for determining

said optical signal to noise ratio is not to measure the noise power directly at the user signal wavelength, but alongside this wavelength, for example between two adjacent user signal wavelengths, and then to extrapolate the measured values. This procedure therefore represents an indirect measurement method, although this measurement method cannot be used when, for example, WDM filters (wavelength demultiplexing filters) are provided in the respective optical transmission path, which decrease the noise power adjacent to the user signal wavelength.

A method for determining the optical signal to noise ratio on an optical transmission path which contains a WDM transmission system is now also known (U.S. Pat. No. 5,513,029). In this known method, additional, weak amplitude modulation with a known modulation level is applied to the respective user signal. The total optical power and the instantaneous modulation level are then determined on the relevant optical transmission path, for example downstream from an optical amplifier EDFA (erbium doped fiber amplifier). The relevant signal to noise ratio can then be calculated from these variables. However, this has the disadvantage that additional modulation is required, and this adversely affects the respective user signal, and hence the signal transmission.

The invention is therefore based on the object of finding a way in which, in the case of a method and circuit arrangement of the type mentioned initially, it is possible to determine the optical signal to noise ratio for optical transmission in a manner which is relatively simple but is nevertheless reliable, without any additional modulation of the respectively transmitted optical user signal being required.

According to the invention, the object as described above is achieved, in the case of a method of the type mentioned initially, in that the optical signal is received together with the optical noise transmitted with it by an optical filter whose optical output signal is converted in a detection device to an electrical signal which corresponds to it, in that either the mid-frequency of the optical filter or the detection device is modulated cyclically with a modulation signal (Uₘ), such that the electrical signal which is emitted said by detection device (Det) appears with a DC component, from which the received total light power Pₜₒₜ is determined, and with a time-dependent modulation component, from which the signal power Pₛₑ of said user signal is determined, and in that the optical signal to noise ratio (OSNR) is determined using the relationship:

$$OSNR = \frac{Pse}{Ptot - Pse}$$

The invention results in the advantage that the characteristic variables which are required for determining the optical signal to noise ratio for optical transmission can be determined in a relatively simple manner, without having to subject the respective user signal to additional modulation. In this case, the invention is based on the knowledge that, as will be seen in more detail further below, an electrical signal which is obtained from the respectively transmitted optical signal has a DC component, which is in practice characteristic of the received total light power, and a time-dependent modulation component, from which the signal power of said user signal can be determined, when an optical filter which receives the relevant noisy user signal or a detection device which receives the optical signal and converts it to an electrical signal is modulated cyclically by means of a modulation signal.

The relevant optical filter is preferably modulated sinusoidally. This makes it particularly simple to determine the signal power of said user signal.

In the case of the method according to the present invention, it is particularly advantageous for the signal power of the user signal to be derived solely from a time-dependent modulation component which corresponds to twice the modulation frequency. As will be seen further below, this makes it possible to determine said signal power in a particularly simple manner.

A calibration characteristic of the optical filter is expediently recorded for at least one frequency range, before determining the optical signal to noise ratio. This measure makes it easier to determine the signal power of said user signal accurately.

In order to make it possible to compensate for any disturbance variables which may be contained in the optical filter and in the detection device, the signal path which supplies the optical signal is expediently interrupted. This then makes it possible to compensate for the relevant disturbance variables such that they have no negative influence on the measurement processes that are subsequently carried out.

A circuit arrangement having an optical filter, which is followed by a detection device which, in response to an optical signal being supplied to it, emits an electrical output signal which corresponds to this optical signal, and having an evaluation device downstream from the detection device, is expediently used to carry out the method according to the invention. According to the invention, this circuit arrangement is characterized in that either the optical filter or the detection device which is downstream from it can be modulated cyclically by a modulation signal at a frequency ωₘ about the mid-frequency ν₀ of the user signal,

in that the detection device which follows the relevant optical filter is furthermore connected on the output side to a modulation device, whose input side is also connected to signal sources, which emit modulation signals corresponding to said modulation frequency ωₘ or corresponding to multiples of said modulation frequency ωₘ at which said optical filter or said detection device is modulated,

and in that the modulation device is connected on the output side to a signal processing device, which is part of the evaluation device, forms an electrical signal which indicates said optical signal to noise ratio and/or forms the variables which are used for calculating the relevant optical signal to noise ratios, from a DC signal component of the output signal which is emitted by the detection device, and from the time-dependent modulation signals which are emitted by the modulation device. The mid-frequency ν₀ which has been mentioned above satisfies the relationship ν₀=c/λ₀, where c is the speed of light and λ₀ is the mid-wavelength of the user signal.

The invention results in the advantage that only a relatively low level of circuitry complexity is required overall in order to make it possible to determine the optical signal to noise ratio for optical transmission of a user signal, without this user signal itself being subjected to modulation. Only a small number of circuit parts are required in order to make it possible to determine the characteristic variables which are required for the relevant optical signal to noise ratio.

The pass characteristic of the optical filter or the detection device can preferably be modulated mechanically and/or electrically by means of said modulation signal.

This results in the advantage of a particularly low level of circuitry complexity in order to make it possible to carry out the relevant modulation.

It is also advantageous to be able to emit the modulation signal to said optical filter and/or to said detection device as a digital signal via a digital to analogue converter. In consequence, a particularly low level of circuitry complexity is required for carrying out said modulation and for carrying out the mathematical calculations mentioned below, which allow a high level of precision for the result signals.

A spectrum analyzer may possibly be provided as the optical filter. In this case, no separate filter need be constructed.

A sinusoidal signal is expediently used as the modulation signal, which means that only a relatively simple evaluation device is required, as will also be seen further below.

For the situation where the optical signal transmission path via which said optical user signal is transmitted has a number of optical transmission channels at different user signal frequencies which are present at the same time, the circuit arrangement according to the invention preferably includes at least a corresponding number of detection devices. It is then possible to monitor the signal to noise ratios of all the optical transmission channels which are present and/or used on the relevant optical signal transmission path.

The detection device preferably has at least one photodiode. This results in the advantage of a particularly low level of circuitry complexity being required for implementation of the detection device.

It is furthermore advantageous for signal processing for the electrical signals emitted by the detection device to be processed as digital signals, once analogue to digital conversion has been carried out. This makes it possible to use a digital evaluation device which operates particularly efficiently.

An optical switch is preferably provided in the input circuit of said optical filter, which switch is opened during calibration and offset compensation for the circuit branch which comprises said optical filter and the detection device. This results in the advantage that calibration and offset compensation can be carried out in a particularly simple manner in the circuit branch which has just been mentioned.

The invention will be explained in more detail in the following text using, by way of example, a drawing.

The drawing shows an exemplary embodiment of a circuit arrangement according to the invention, whose design will be explained first of all.

The circuit arrangement illustrated in the drawing has an input connection IN by means of which it can be connected to an optical signal transmission path, via which a noisy optical signal is transmitted, which contains at least one user signal that is transmitted at a specific user signal frequency or wavelength. The input connection IN is followed by an optical switch OS, which is closed for transmission of said optical signal or user signal and is open when, for example, calibration and compensation processes are intended to be carried out in the downstream circuit part.

The optical switch OS is followed by an optical filter OF which may be, for example, a spectrum analyzer or a Fabry-Perot interferometer. This optical filter OF is connected on the output side to a detection device Det, whose input side has a photodiode FD for receiving the relevant optical user signal and for emitting an electrical output signal or current which corresponds to this optical user signal. This photodiode FD is followed by an amplifier V1, whose output side is followed by a low-pass filter TPD.

The detection device Det is followed by an analogue to digital converter ADC, which converts the analogue signals supplied to it on the input side to digital signals, which it emits. These digital signals are emitted to an evaluation device DSP which follows the relevant analogue to digital converter ADC. In the present case, this evaluation device DSP is a digital signal processor, which allows the signals which are supplied to it to be processed digitally, and also allows digital signals to be emitted.

The digital signal processor DSP is connected on the input side firstly by means of a low-pass filter TPP and secondly by means of a high-pass filter HP1 to the output of the analogue to digital converter ADC mentioned above. DC components, or the digital signals which correspond to them, in the output signal which is emitted by the detector device Det can be passed on via the low-pass filter TPP and, in contrast, only modulation components, which represent high-frequency signal components, or digital signals which correspond to them in the relevant output signal, can be passed on via the high-pass filter HP1, and this will be described in more detail further below.

The low-pass filter TPP is connected on the output side to a signal processing device SPD within the evaluation device or the digital signal processor DSP. The high-pass filter HP1 is connected on the output side to the first inputs of modulators Mod1 to Mod6 which are part of a modulation device. These modulators Mod1 to Mod6 are connected by means of further inputs to signal sources Sig1 to Sig6, via which different signals are emitted at the respective user signal frequency or at a multiple of this frequency. The signal source Sig1 which is connected to the modulator Mod1 thus emits a signal corresponding to sin ((ωₘ^{t}). The signal source Sig2 which is connected to the modulator Mod2 emits a signal corresponding to cos (ωₘ^{t}) The signal source Sig3 which is connected to the modulator Mod3 emits a signal corresponding to sin (2ωₘ^{t}). The signal source Sig4 which is connected to the modulator Mod4 emits a signal corresponding to cos (2ωₘ^{t}). The signal source Sig5 which is connected to the modulator Mod5 emits a signal corresponding to sin (3ωₘ^{t}) and, finally, the signal source Sig6 which is connected to the modulator Mod6 emits a signal corresponding to cos (3ωₘ^{t}).

The modulators Mod1 to Mod6 are each connected on the output side via a respective low-pass filter the low pass filter TP1, TP2, TP3, TP4, TP5 and TP6 to inputs of the already mentioned signal processing device SPD.

The signal processing device SPD has output connections O1, O2, O3, O4, from which the characteristic variables which are used for determining the optical signal to noise ratio on the optical transmission path, or an output variable which indicates the relevant optical signal to noise ratio directly, can be emitted. On the output side, the relevant signal processing device SPD is also connected to the operating input of the already mentioned optical switch OS.

The optical filter OF as mentioned above receives at a modulation input a sinusoidal modulation signal Um from a modulation signal source Sigm which, in the present case, is shown as being part of the digital signal processor DSP. This modulation signal source Sigm is connected on the output side via a digital to analogue converter DAC and via an amplifier V and a high-pass filter HP2 downstream from this amplifier V to the relevant modulation input of the optical filter OF. The significance of this circuit measure will be described in more detail further below. However, it should be noted at this point that, instead of the cyclic modulation of the optical filter OF, the detection device Det, to be precise in particular the photodiode FD which is part of it, may also be modulated in an appropriate manner. This modulation is either mechanical modulation and/or electrical modulation of the optical filter or of the detection detection Det such that the output signal is dependent on the wavelength of the user signal and on the modulation (modulation frequency, modulation level, modulation form).

Now that the design of the circuit arrangement illustrated in the drawing has been explained, the following text will now describe the mathematical significance of the individual signals which occur in the relevant circuit arrangement, and their relationships, in order in this way to explain the method of operation of the relevant circuit arrangement, and hence the method according to the invention.

The following analysis is based on a circuit design, as is illustrated in the drawing, and on the assumption that the signal bandwidth of a user signal—which is considered on its own here—is very much narrower than the pass band of the optical filter OF. The direct current which flows in the photodiode FD of the detection device Det on receiving the noisy user signal is proportional to the sum of two integrals: it satisfies the following relationship:

$$I ∝ {\int }_{0}^{∞} {P}_{s}^{′} ( ν ) \cdot T ( ν ) \cdot ⅆ ν + {\int }_{0}^{∞} {ASE}^{′} ( ν ) \cdot T ( ν ) \cdot ⅆ ν \qquad ( 1 )$$

where P′ₛ (ν) indicates the signal power density upstream of the optical filter OF,

T(ν) indicates the pass function or transmission of the optical filter OF,

ASE′ (ν) indicates the noise power density upstream of the optical filter OF, and ν indicates a frequency or wavelength.

If the user signal is in the form of a monochromatic signal wave, the first integral in the relationship (1) mentioned above can be written as follows:

$${\int }_{0}^{∞} {P}_{s} \cdot δ ( ν - {ν}_{s} ) \cdot T ( ν ) \cdot ⅆ ν = {P}_{s} \cdot T ( ν = {ν}_{s} \qquad ( 2 )$$

where Pₛ indicates the signal power and νₛ indicates the signal frequency or wavelength of the user signal.

On the assumption that the bandwidth of the optical filter OF is very much narrower than the bandwidth of the optical noise ASE (amplified spontaneous emission), the second integral in the above relationship (1) can be written, approximately, as follows:

$${\int }_{0}^{∞} {ASE}^{′} ( ν ) \cdot {T}_{0} \cdot B \cdot δ ( ν - {ν}_{0} ) \cdot ⅆ ν = {T}_{0} \cdot BW \cdot {ASE}^{′} ( ν = {ν}_{0} \qquad ( 3 )$$

In this relationship, T₀, the transmission of the optical filter OF, satisfies the relationship

T₀=T(ν=ν₀) (4)

where ν₀ indicates the mid-frequency of the optical filter OF.

The term T₀·BW in the relationship (3) represents the area below the pass curve of the optical filter OF. BW in this case indicates the pass bandwidth of the optical filter OF.

For further simplification, a linear function can be assumed, to a first approximation, for the frequency dependency of the term ASE′ in the pass band of the optical filter OF. This results in:

ASE′(ν)=ASE′₀·(1+C·ν) (5)

where C is a constant.

The relationship stated at (1) thus becomes:

I∝Pₛ·T(ν=νₛ)+T₀·BW·ASE′₀·(1+C·σ₀) (6)

According to the invention, the pass frequency ν₀ of the optical filter OF is now modulated with a cyclic modulation signal, to be precise in particular with a sinusoidal modulation signal at the frequency ωₘ around the mid-frequency ν₀. The transmission curve of the optical filter OF thus tends to:

T(ν)→T(ν−Δ·sin (ωₘ·t)) (7)

where Δ is the modulation level.

The time-dependent photodiode current thus becomes:

I(t)∝Pₛ·T(νₛ+Δ·sin(ωₘ·t))+T₀·BW·ASE′₀·(1+C·(ν₀+Δ·sin(ωₘ·t))) (8)

If the modulation level Δ is sufficiently small in comparison to the pass bandwidth BW of the optical filter OF (Δ<<BW) and the relationship (8) is developed about the transmission frequency νₛ to form a Taylor series, then, finally, this results in the following relationship:

$$\begin{matrix}I ( t ) ∝ {P}_{s} \cdot T ( {ν}_{s} ) + {T}_{0} \cdot BW \cdot {ASE}_{0}^{′} \cdot ( 1 + C \cdot {ν}_{0} ) + … + sin ( {ω}_{m} \cdot t ) \cdot \\ \{ {P}_{s} \cdot Δ \cdot \frac{\partial T ( ν )}{\partial ν} {\vert}_{{v}_{s}} + {P}_{s} \cdot \frac{{Δ}^{3}}{8} \cdot \frac{{\partial }^{3} T ( ν )}{\partial {ν}^{3}} {\vert}_{{ν}_{s}} + \\ AhO + {T}_{0} \cdot BW \cdot Δ \cdot {ASE}_{0}^{′} \cdot C \} + sin ( 2 {ω}_{m} \cdot t ) \cdot \\ \{ - {P}_{s} \cdot \frac{{Δ}^{2}}{4} \cdot \frac{{\partial }^{2} T ( ν )}{\partial {ν}^{2}} {\vert}_{{v}_{s}} + {P}_{s} \cdot \frac{{Δ}^{4}}{96} \cdot \frac{{\partial }^{4} T ( ν )}{\partial {ν}^{4}} {\vert}_{{ν}_{s}} + AhO \} + \\ sin ( 3 {ω}_{m} \cdot t ) \cdot \{ - {P}_{s} \cdot \frac{{Δ}^{3}}{24} \cdot \frac{{\partial }^{3} T ( ν )}{\partial {ν}^{3}} {\vert}_{{v}_{s}} - AhO \} + AhO\end{matrix} \qquad ( 9 )$$

where AhO indicates higher-order components.

After a number of conversions and combination of terms, the following relationship is obtained from the relationship (9):

I(t)∝P_{S}·T(ν_{S})+T₀·BW·ASE′₀·(1+C·ν₀)++sin(ωₘ·t)·{P_{S}·F_{Cal1}(ωₛ, Δ)}+sin(2ωₘ·t)·{P_{S}F_{Cal2}(ν_{S}, Δ)}+sin(3ωₘ·t)·{P_{S}·F_{Cal3}(ωₛ, Δ)}+AhO (10)

where C is a constant, F_{Cal1} is the frequency-dependent profile of the filter curve of the optical filter OF at the frequency ωₘ, E_{Cal2} is the frequency-dependent profile of the filter curve of the optical filter OF at the frequency 2ωₘ, and F_{Cal3} is the frequency-dependent profile of the filter curve of the optical filters OF at the frequency 3ωₘ. Ps indicates the signal power of the user signal at the transmission frequency ν₅.

It follows from the relationship (10) stated above that the DC component of the photodiode FD in the circuit arrangement illustrated in the drawing corresponds to the total received light power Pₜₒₜ which is available at the output of the analogue to digital converter ADC. This total light power Pₜₒₜ comprises the signal power component Pₛ·T(ωₛ), which is the first term in the first line of the relationship (10), plus the optical noise power, which is the second term in the first line of the relationship (10).

A time-dependent modulation component from the relationship (10) stated above is used first of all in order now to determine solely a signal component which is characteristic of the user signal, or the signal power Pₛₑ. The term at the frequency 2ωₘ, that is to say the term at twice the modulation frequency at which the optical filter OF is modulated, is preferably used for this purpose. At this frequency which is twice the modulation frequency, the relationship (10) becomes:

Iₛ=Cₛ·sin(2ωₘ·t)·{Pₛ·F_{Cal2}(ωₛ, Δ)} (11)

where Cₛ is a constant.

Using the first term in the relationship (10), the following expression can thus be obtained for ωₛ=ω₀:

Pₛₑ=Pₛ·T(ωₛ=ω₀) (12)

The optical noise power P_{ASE} can thus be obtained as the difference between the total received light power Pₜₒₜ and the signal power Pₛₑ, which has already been considered, as:

P_{ASE}:=T₀·BW·ASE′₀·(1+C·ω₀)=Pₜₒₜ−Pₛ·T(ωₛ=ω₀)=Pₜₒₜ−Pₛₑ (13)

The optical signal to noise ratio OSNR can thus be calculated as follows:

$$OSNR = \frac{Pse}{{P}_{ASE}} = \frac{Pse}{Ptot - Pse} \qquad ( 14 )$$

The present invention is now based on the principle of mathematical relationships considered above. According to the invention, the signal power Pₛₑ of the user signal is derived at twice the frequency of the modulation frequency ωₘ. This is because the filter curve of the optical filters OF and hence its output voltage in this case has a maximum at the filter mid-frequency ν₀, so that the signal evaluation at this filter mid-frequency is particularly simple. The calibration curve F_{Cal2} of the relevant optical filter has further peak values located symmetrically about the filter mid-frequency at twice the modulation frequency, as already mentioned, which further peak values are, in fact, of the opposite plurality to the value at the filter mid-frequency ν₀ and, furthermore, have a smaller amplitude.

In principle, the signal power Pₛₑ could also be derived taking account of other time-dependent modulation components and hence taking account of other calibration curves, as is indicated in the relationship (10) stated above. If, by way of example, the relevant signal path Pₛₑ of the user signal is derived from a time-dependent modulation component which corresponds to the modulation frequency itself, then it must be remembered that, in this case, the calibration curve F_{Cal1} has the value 0 at the filter mid-frequency, and has a positive peak value and a negative peak value, respectively, on the two sides of this mid-frequency (S-shaped signal). In order to obtain a signal which can be evaluated, the mid-frequency of the optical filter OF would in this case need to be shifted in frequency toward one of the relevant peak value frequencies.

According to the present invention, in the case of the circuit arrangement which is used to carry out the invention and as is illustrated by way of example in the drawing, the signal sources Sig1, Sig3 and Sig5 are provided, taking account of the relationships as explained above. The sinusoidal output signals from these signal sources allow the signal components, which are supplied via the high-pass filter HP1, in the output signal from the detection device Det to be processed in the modulators Mod1, Mod3 and Mod5, in order to allow the signal processing device SPD to determine (together with the DC components of the signal component which is received via the low-pass filter TPP) the optical noise power and the signal power Pₛₑ, and hence to determine the optical signal to noise ratio OSNR, as is indicated in conjunction with the relationships (12), (13) and (14).

The signal sources Sig2, Sig4 and Sig6, which emit cosin signals, as well as the modulators Mod2, Mod4 and Mod6 which are connected to them, carry out a fundamental role for the purposes of the present invention. However, in practice, the circuit elements of the signal processing device SPD make it possible to supply signals from the signal components which are emitted by the detection device Det via the high-pass filter HP1, which signals may be used for tasks other than those explained, for example in order to carry out phase regulation of the modulation signal Um.

The above explanation has described how, in the case of the method and the circuit arrangement according to the present invention, the pass frequency of the optical filter OF, or of the spectrum analyzer which contains this optical filter, is modulated cyclically. The relevant optical filter OF is modulated mechanically and/or electrically in the course of this modulation. In the case of mechanical modulation, the relevant optical filter is deflected about its mid-frequency. A corresponding effect can be achieved by electrical modulation, for example by modulating the reflective index of the relevant optical filter.

Instead of modulation of the optical filter OF, it is also possible to modulate the detection device Det in the circuit arrangement according to the invention, to be precise in particular to modulate the photodiode FD in this detection device Det. This corresponds to a transformation of the explained mathematical relationships from the frequency domain to the location domain.

In order to make it possible to monitor an optical transmission band which extends, for example from 1530 nm to 1560 nm, and to make it possible to determine the optical signal to noise ratios for the user signals which are transmitted in this case, the relevant transmission band may be subdivided, for example, in the transmission window with a width of 0.8 nm (for example corresponding to the 100 GHz grid according to the ITU). In this case, each such transmission window may then be monitored appropriately, with the optical signal noise ratio in this window then being determined in the manner as explained above. For this purpose, the number of the relevant circuit arrangements according to the invention which are provided, at least with their detection devices, corresponds to the number of optical transmission channels or transmission windows at different user signal frequencies which are present at the same time. Only one photodiode therefore need be provided in each case for each transmission window. At this point, it should also be noted that each channel can additionally be monitored for serviceability or failure just by measuring the respective photodiode current, without needing to provide a separate measurement arrangement for this purpose.

The signal processing device SPD which is illustrated in the drawing is, apart from this, connected via a control line to the operating input of the optical switch OS, which is normally closed and which may be opened by a control signal from the relevant signal processing device SPD. Calibration and offset compensation processes can then be carried out, when a switch is opened in this manner, in the circuit branch which comprises the optical filter OF and the detection device Det.

With regard to the various high-pass and low-pass filters which have been mentioned, it should also be noted that their cut-off frequencies are in each case chosen such that these filters allow signal components to be passed on (in analogue or digital form) just on the basis of the location at which they are in each case used.

1. A method for determining the optical signal to noise ratio (OSNR) for optical transmission of a noisy optical signal which is transmitted via an optical signal transmission path and which contains a user signal, by optical detection of the relevant optical signal and by determination of the user signal power and the noise power in order to form the optical signal to noise ratio,
characterized in that the optical signal is received together with the optical noise transmitted with it by an optical filter (OF) whose optical output signal is converted in a detection device (Det) to an electrical signal which corresponds to it, in that either the mid-frequency of the optical filter (OF) or the detection device (Det) is modulated cyclically with a modulation signal (Uₘ),
in that the electrical signal which is emitted by said detection device (Det) appears with a DC component, from which the received total light power (Ptot) is determined, and with a time-dependent modulation component, from which the signal power (Pse) of said user signal is determined,
and in that the optical signal to noise ratio (OSNR) is determined using the relationship:
$$OSNR = \frac{Pse}{Ptot - Pse}$$

2. The method as claimed in claim 1, characterized in that the optical filter (OF) is modulated cyclically, in particular sinusoidally.

3. The method as claimed in claim 1 or 2, characterized in that the signal power (Pse) of the user signal is derived solely from a time-dependent modulation component which corresponds to twice the modulation frequency.

4. The method as claimed in one of claims 1 to 3, characterized in that a calibration characteristic of the optical filter (OF) is recorded for at least one frequency range before determining the optical signal to noise ratio.

5. The method as claimed in one of claims 1 to 4, characterized in that the signal path which supplies the optical signal is interrupted in order to compensate for any disturbance variables which may be contained in the optical filter (OF) and in the detection device (Det).

6. A circuit arrangement for carrying out the method as claimed in one of claims 1 to 5, having an optical filter (OF), which is followed by a detection device (Det) which, in response to an optical signal being supplied to it, emits an electrical output signal which corresponds to this optical signal, and having an evaluation device (DSP) downstream from the detection device (Det),
characterized
in that either the optical filter (OF) or the detection device (Det) which is downstream from it can be modulated cyclically by a modulation signal (Um) at a frequency ωₘ about the mid-frequency ν₀ of the user signal, in that the detection device (Det) which follows the relevant optical filter (OF) is furthermore connected on the output side to a modulation device (Mod1 to Mod6), whose input side is also connected to signal sources (Sig1 to Sig6), which emit modulation signals corresponding to said modulation frequency ωₘ or corresponding to multiples of said modulation frequency ωₘ at which said optical filter (OF) is modulated,
and in that the modulation device (Mod1 to Mod6) is connected on the output side to a signal processing device (SPD), which is part of the evaluation device (DSP), forms an electrical signal (OSNR) which indicates said optical signal to noise ratio and/or forms the variables (Pse, Ptot) which are used for calculating the relevant optical signal to noise ratio, [lacuna] a DC signal component of the output signal which is emitted by the detection device (Det), and from the time-dependent modulation signals which are emitted by the modulation device.

7. The circuit arrangement as claimed in claim 6, characterized in that the pass characteristic of the optical filter (OF) can be modulated mechanically and/or electrically by means of said modulation signal.

8. The circuit arrangement as claimed in claim 7, characterized in that the modulation signal (ωₘ) can be emitted to said optical filter (OF) and/or to said detection device (Det) as a digital signal via a digital to analogue converter (DAC).

9. The circuit arrangement as claimed in one of claims 6 to 8, characterized in that a spectrum analyzer is provided as the optical filter (OF).

10. The circuit arrangement as claimed in one of claims 6 to 9, characterized in that a sinusoidal signal is used as the modulation signal.

11. The circuit arrangement as claimed one of claims 6 to 10, characterized in that, at least together with their detection devices (Det), a number of these circuit arrangements are provided, corresponding to the number of optical transmission channels at different user signal frequencies which occur at the same time.

12. The circuit arrangement as claimed in one of claims 6 to 10, characterized in that the detection device (Det) is formed by at least one photodiode.

13. The circuit arrangement as claimed in one of claims 6 to 12, characterized in that the electrical signals emitted by the detection device (Det) are processed as digital signals once analogue to digital version (ADC) has been carried out.

14. The circuit arrangement as claimed in one of claims 6 to 13, characterized in that the input circuit of said optical filter (OF) includes an optical switch (OS) which is opened during calibration and for offset compensation for the circuit branch which comprises said optical filter (OF) and the detection circuit (Det).
